(19) United States
(12) Patent Application Publication
(10) Pub. No.: US 2025/0242724 A1
(43) Pub. Date: Jul. 31, 2025

(54) FUEL CELL SYSTEM

(71) Applicant: TOYOTA JIDOSHA KABUSHIKI KAISHA, Toyota-shi (JP)

(72) Inventor: Tomoyuki NISHIDA, Miyoshi-shi (JP)

(73) Assignee: TOYOTA JIDOSHA KABUSHIKI KAISHA, Toyota-shi (JP)

(21) Appl. No.: 18/928,176

(22) Filed: Oct. 28, 2024

(30) Foreign Application Priority Data
Jan. 31, 2024 (JP) 2024-013440

(51) Int. Cl. B60L 58/31; B60L 50/71; B60L 58/33

(52) U.S. Cl. CPC B60L 58/31; B60L 50/71; B60L 58/33

(57) ABSTRACT

The fuel cell system includes a plurality of fuel cell stacks including a first fuel cell stack, an air supply system that supplies air to each of the fuel cell stacks, a hydrogen supply system that supplies hydrogen to each of the fuel cell stacks, and a control device that controls the air supply system and the hydrogen supply system to execute an activation process for activating the fuel cell stacks, wherein the activation process includes a first process of activating the air supply system with electric power supplied from other than the fuel cell stacks to activate the first fuel cell stack, and a second process of activating the fuel cell stacks except the first fuel cell stack by activating the air supply system with electric power supplied from the first fuel cell stack after activation of the first fuel cell stack.

### CROSS-REFERENCE TO RELATED APPLICATION

This application claims priority to Japanese Patent Application No. 2024-013440 filed on Jan. 31, 2024, incorporated herein by reference in its entirety.

### BACKGROUND

### 1. Technical Field

The technology disclosed herein relates to a fuel cell system including a plurality of fuel cell stacks.

### 2. Description of Related Art

In fuel cell systems, high-voltage components are typically used during the start-up of fuel cells. When a trouble occurs in a high-voltage power supply in such a fuel cell system, the start-up of the fuel cell may fail.

Japanese Unexamined Patent Application Publication No. 2014-041808 (JP 2014-041808 A) discloses a fuel cell system that starts a fuel cell without assist from a high-voltage power supply when the high-voltage power supply has a trouble. In this fuel cell system, an emergency air supply device for supplying air to the fuel cell stack is detachably provided in place of an air blower that requires the high-voltage power supply when the high-voltage power supply has a trouble.

### SUMMARY

A novel technology for starting a plurality of fuel cell stacks is provided herein.

A fuel cell system is disclosed herein. In one aspect, the fuel cell system includes:
a plurality of fuel cell stacks including a first fuel cell stack;
an air supply system configured to supply air to each of the fuel cell stacks;
a hydrogen supply system configured to supply hydrogen to each of the fuel cell stacks; and
a control device configured to control the air supply system and the hydrogen supply system to perform a start-up process for starting the fuel cell stacks.

The start-up process includes:
a first process for starting the first fuel cell stack by operating the air supply system with electric power supplied from a source other than the fuel cell stacks; and
a second process for starting the fuel cell stacks except the first fuel cell stack by operating the air supply system with electric power supplied from the first fuel cell stack after the first fuel cell stack is started.

In the above configuration, the first fuel cell stack out of the plurality of fuel cell stacks is started by operating the air supply system with the electric power supplied from the source other than the fuel cell stacks. The fuel cell stacks except the first fuel cell stack are started by operating the air supply system with the electric power supplied from the first fuel cell stack after the first fuel cell stack is started. In this way, the fuel cell stacks can be started.

In the above aspect, the air supply system may include a first air supply device and a second air supply device having a higher driving voltage than the first air supply device.

In the first process, the first air supply device may be operated.

In the second process, the second air supply device may be operated.

In the above configuration, the first fuel cell stack is started by the first air supply device having a relatively low driving voltage. The fuel cell stacks except the first fuel cell stack are started by operating the second air supply device having a relatively high driving voltage with the electric power supplied from the first fuel cell stack after the first fuel cell stack is started. In this way, the fuel cell stacks can be started with the relatively low voltage.

In the above aspect, the second process may be started after output electric power of the first fuel cell stack exceeds a predetermined threshold value.

After the second process is started, air may be supplied from the second air supply device to the first fuel cell stack instead of the first air supply device.

In the above configuration, air is supplied from the second air supply device to the first fuel cell stack when the output electric power of the first fuel cell stack exceeds the predetermined threshold value and the relatively high driving voltage of the second air supply device can be supplied. Since the second air supply device has a higher driving voltage than the first air supply device, the amount of air supplied from the second air supply device may be larger than the amount of air supplied from the first air supply device. Thus, the first fuel cell stack may be operated more efficiently.

In the above aspect, in the second process, the fuel cell stacks except the first fuel cell stack may be started at the same timing.

In the above configuration, the fuel cell stacks can be started relatively quickly.

In the above aspect, in the second process, at least some of the fuel cell stacks except the first fuel cell stack may be started at different timings.

When the fuel cell stacks are to be started at the same timing with the output electric power of the first fuel cell stack, it is conceivable that the electric power for starting the fuel cell stacks is insufficient. In the above configuration, at least some of the fuel cell stacks are started at different timings. Thus, it is possible to suppress the occurrence of the power shortage described above.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a plurality of fuel cell stacks constituting a fuel cell system;

FIG. 2 shows a schematic diagram of an air supply system, a hydrogen supply system, and a cooling system for each fuel cell stack;

FIG. 3 shows a schematic diagram of an air supply system to a particular fuel cell stack;

FIG. 4 shows a flow chart of the activation process of the control device;

FIG. 5 shows a time chart of the activation of the fuel cell stacks according to the first embodiment; and

FIG. 6 shows a time chart of the activation of each fuel cell stack according to the second embodiment.

### DETAILED DESCRIPTION OF EMBODIMENTS

### Example 1

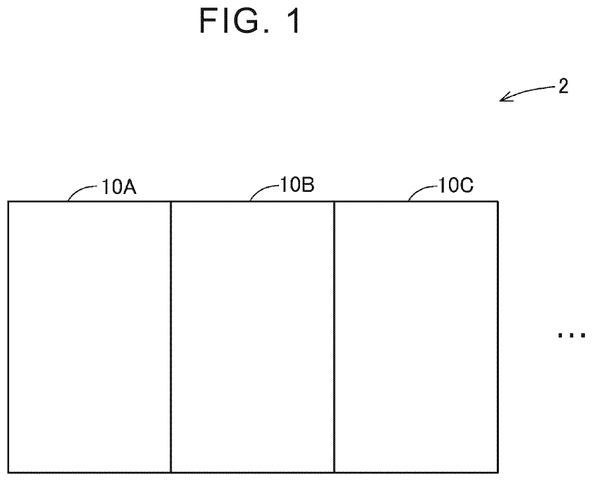

As shown in FIG. 1, the fuel cell system 2 of the present embodiment includes a plurality of fuel cell stacks 10. Although a 10C is illustrated in FIG. 1 from three fuel cell stacks 10A, the number of fuel cell stacks is exemplified, and may be two or four or more. The fuel cell system 2 of the present embodiment is mounted on, for example, a fuel cell electric vehicle. Hereinafter, a fuel-cell is referred to as an abbreviation for FC (Fuel Cell). In the following description, when 10C is omitted from the fuel cell stack 10A, it is sometimes referred to as FC stack 10.

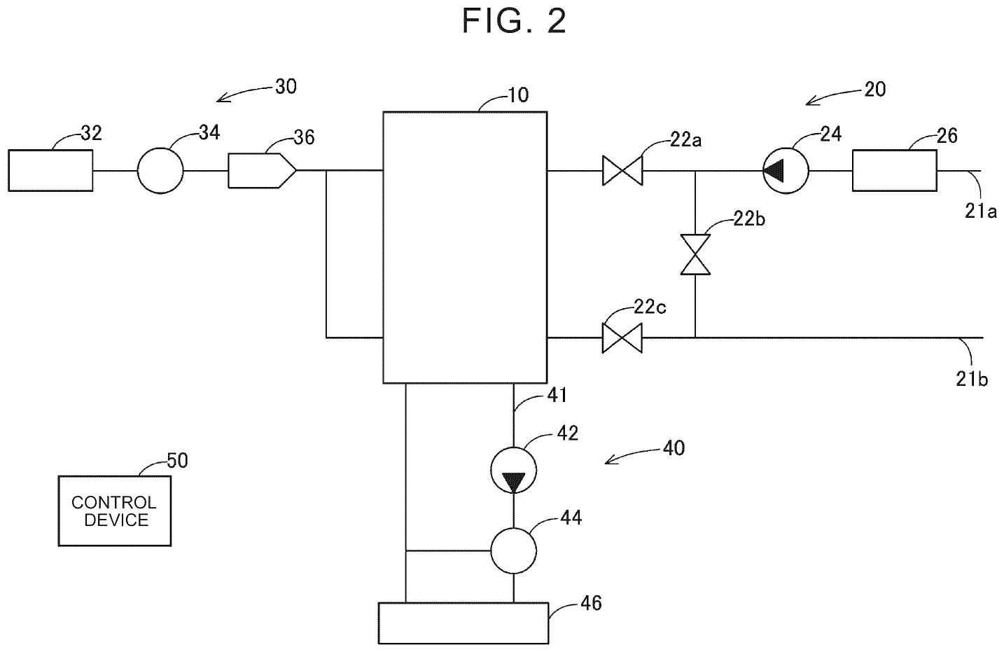

As shown in FIG. 2, FC stacks 10 are provided with an air supply system 20, a hydrogen supply system 30, and a cooling system 40. The air supply system 20 supplies oxygen-containing air to FC stack 10. The hydrogen supply system 30 supplies hydrogen gas containing hydrogen to FC stacks 10. In FC stack 10, oxygen contained in the air supplied from the air supply system 20 and hydrogen contained in the hydrogen gas supplied from the hydrogen supply system 30 react with each other to generate electric power. When power is generated, FC stacks 10 generate heat. Therefore, a cooling system 40 is provided to cool FC stacks 10. In addition, FC device 2 is provided with a control device 50 for controlling FC stacks 10 and the systems 20, 30, and 40.

The air supply system 20 includes an air inflow path 21a, an air discharge path 21b, a plurality of valves 22a to 22c, an air compressor 24, and an air flow meter 26. The air flowing in from the air inflow path 21a is supplied to FC stacks 10, and then discharged to the outside from the air discharge path 21b. The air flow meter 26 is provided in the middle of the air inflow path 21a, and can measure the flow rate of the air flowing into the air inflow path 21a from the outside.

An air compressor 24 is provided downstream of the air flow meter 26. The air compressor 24 is a compressor, and compresses the air flowing in from the air inflow path 21a, and supplies the compressed air to FC stacks 10. The operation of the air compressor 24 is controlled based on the flow rate of air measured by the air flow meter 26.

The plurality of valves 22a to 22c is a valve for adjusting a supply volume of air and switching a supply path of air.

The hydrogen supply system 30 includes a hydrogen tank 32 for storing hydrogen gas containing hydrogen, an intermediate pressure valve 34, and an injector 36. The hydrogen-tank 32 is commonly provided from FC stacks 10A to 10C. When the intermediate pressure valve 34 is released, the hydrogen gas flowing from the hydrogen tank 32 is supplied to the injector 36. The injector 36 adjusts the pressure of the hydrogen gas supplied to FC stack 10.

The cooling system 40 includes a flow path 41 through which a liquid-based refrigerant (for example, water or LLC) flows, a water pump 42, a three-way valve 44, and a radiator 46. The water pump 42 discharges the coolant toward FC stack 10. The three-way valve 44 adjusts the flow rate of the refrigerant flowing through each of the refrigerant flow path passing through the radiator 46 and the refrigerant flow path bypassing the radiator 46. The radiator 46 cools the heated coolant passing through FC stack 10.

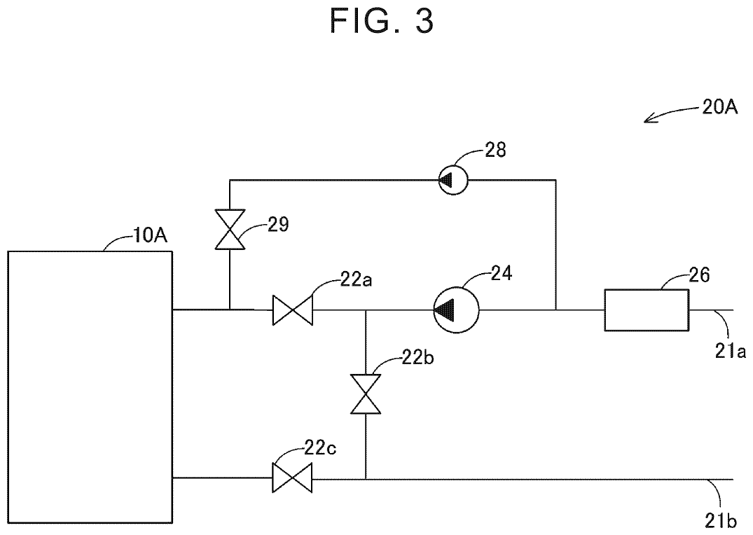

Further, as shown in FIG. 3, the configuration of the air supplying system provided in at least one FC stack of the plurality of FC stacks 10 differs. FIG. 3 shows an air supply system 20A provided in FC stack 10A and FC stack 10A. The air supply system 20A further includes a blower 28 and a valve 29. The blower 28 is also a compressor, and compresses the air flowing in from the air inflow path 21a, and supplies the compressed air to FC stack 10. The operation of the blower 28 is controlled based on the flow rate of air measured by the air flow meter 26. The pressure ratio of the air compressor 24 (i.e., the ratio between the pressure flowing out of the air compressor 24 and the pressure of the air flowing into the air compressor 24) is higher than the pressure ratio of the blower 28. On the other hand, the driving voltage of the air compressor 24 is higher than the driving voltage of the blower 28. The valve 29 switches the air supply path between a blower path through the blower 28 and an air compressor path through the air compressor 24. Specifically, when the 25 valve 22a is closed and the valve 29 is opened, air flows through the blower path. Also, when the valve 29 is closed and the valve 22a is opened, air flows through the air compressor path.

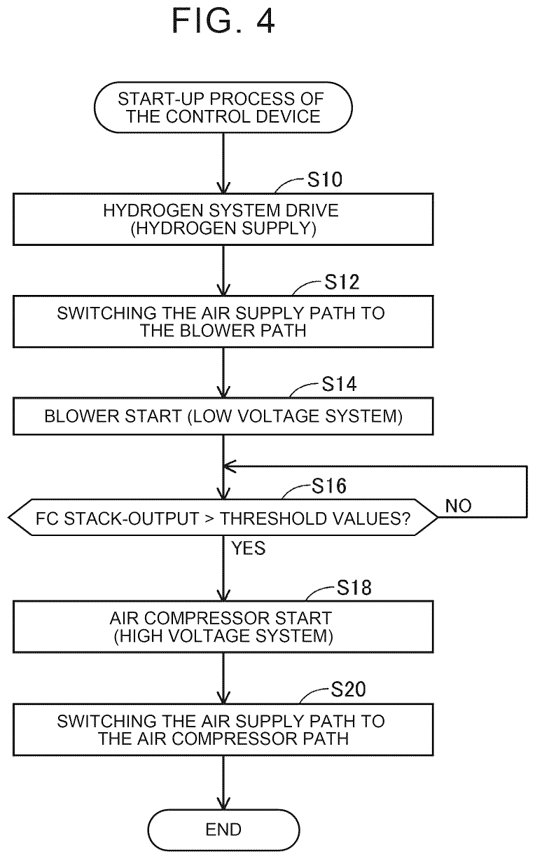

As described above, since the pressure ratio of the air compressor 24 is higher than the pressure ratio of the blower 28, when the air compressor 24 is used, the flow rate of the air supplied to FC stack 10A is larger (that is, the air can be efficiently supplied 30 to FC stack 10A) than when the blower 28 is used. However, since the driving voltage of the air compressor 24 is higher than the driving voltage of the blower 28, it is necessary to provide a high voltage power supply having a relatively high voltage in order to drive the air compressor 24. That is, a high-voltage power supply is required to activate FC stack 10. In order to solve such a problem, the control device 50 of FC device 2 of the present application executes the following process of FIG. 4.

With reference to FIG. 4, a start-up process executed by the control device 50 will be described. The activation process is started, for example, by triggering FC vehicle to be switched on.

In S10 of FIG. 4, the control device 50 drives the hydrogen supply system 30 in FC stack 10A. Specifically, the control device 50 opens the intermediate pressure valve 34 and starts control of the injector 36. As a consequence, the hydrogen-gas is supplied to FC stack 10A.

In S12, the control device 50 switches the air supply path for supplying air from the air supply system 20A to FC stack 10A to the blower supply path. Specifically, the control device 50 closes the valve 22a and opens the valve 29. As a result, the air flowing into the air inflow path 21a flows into the blower path.

The control device 50 activates the blower 28 in S14. Specifically, the control device 50 causes a low-voltage power supply (not shown) to supply power to the blower 28. Consequently, the air flowing in from the air inflow path 21a is compressed by the blower 28, and the compressed air is supplied to FC stack 10A. Here, the low voltage power supply may be a self-power supply (for example, a battery) provided in the fuel cell system 2, or may be an external power supply (including a commercial power supply).

When S14 process is completed, both hydrogen gas and air are supplied to FC stack 10A. Thus, FC stack 10A initiates (i.e., is activated) power generation. The output-voltage of FC stack 10A gradually increases to a certain value (that is, the upper-limit generated power of FC stack 10A) as the supply-amount of hydrogen gas and air increases.

The control device 50 monitors in S16 that the power of FC stack 10A exceeds thresholds. Here, the threshold value is set to a voltage necessary for driving the air compressor 24. That is, the threshold value is set to a voltage higher than the driving voltage of the blower 28. The control device 50 proceeds to S18 if FC stack 10A has an outgoing voltage that exceeds a threshold (YES by S16).

The control device 50 activates the air compressor 24 in S18. Specifically, the control device 50 causes FC stack 10A to provide power to the air compressor 24. As described above, in S18 stage, the output voltage of FC stack 10A is greater than the voltage required to drive the air compressor 24. For this purpose, the air compressor 24 is activated appropriately.

In S20, the control device 50 switches the air supplying path to the air compressor path. Specifically, the control device 50 closes the valve 29 and opens the valve 22a. As a result, the air flowing into the air inflow path 21a flows into the air compressor path. Thereafter, while FC vehicle is activated, for example, the air compressed by the air compressor 24 is supplied from FC stacks 10A to 10C. Although not shown, the control device 50 may stop the supply of power to the blower 28 to the low-voltage power supply after the air supply path is switched to the air compressor path.

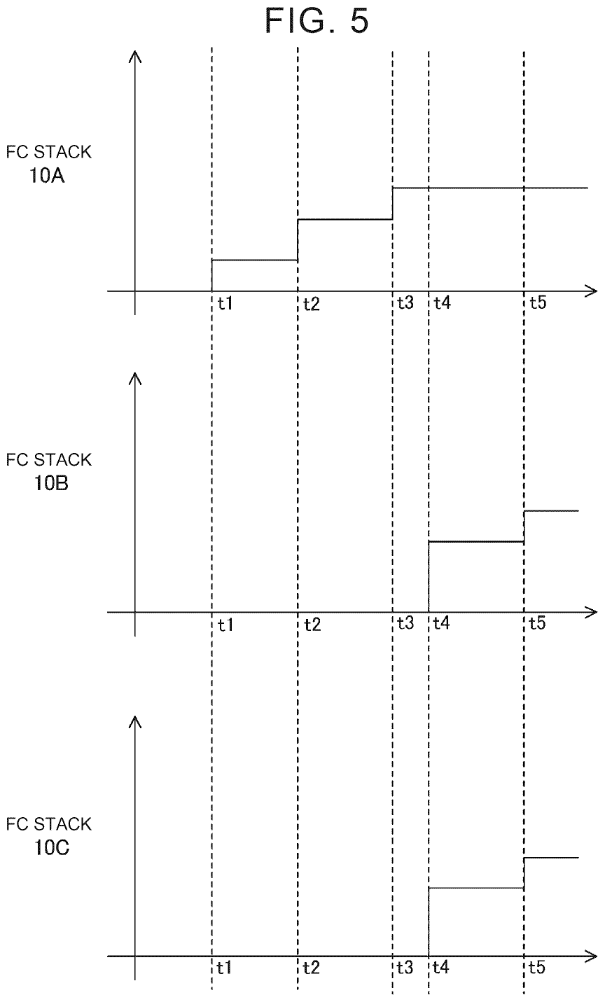

Next, with reference to FIG. 5, a time chart of a specific process realized by the process of FIG. 4 will be described.

In the time t1, FC vehicle is switched on. In this instance, the control device 50 drives the hydrogen supply system 30 in FC stack 10A (S10 in FIG. 4), and switches the air supply path to the blower path (S12), and activates the blower 28 (S14). Consequently, at the time t1, FC stack 10A is activated by using the blower 28 (i.e., the low-voltage power supply), and starts power generation. After the time t1, as the total amount of air and hydrogen supplied to FC stack 10A gradually increases, the output voltage also gradually increases.

At time t2, the output voltage of FC stack 10A exceeds the threshold values (i.e., the voltage required to drive the air compressor 24) (YES by S16). In this case, the control device 50 drives the air compressor 24 by supplying the output-voltage of FC stack 10A to the air compressor 24 (S18), and switches the air supply path to the air compressor path (S20). Consequently, after the time t2, FC stack 10A is activated by using the air compressor 24 (that is, FC stack 10A which is a high-voltage power supply) to generate electric power. After the time t2, as the total amount of air and hydrogen supplied to FC stack 10A gradually increases, the output voltage also gradually increases. In particular, the air supplied from the air compressor 24 has a higher flow rate than the air supplied from the blower 28. Therefore, the output-voltage of FC stack 10A is more likely to be increased after the time t2 when the air compressor 24 is activated than between the time t1 when the blower 28 is activated and the time t2.

At time t3, the output voltage of FC stack 10A is increased to around its upper limit output voltage, and the activation of FC stack 10A is completed.

Thereafter, at the time t4, the control device 50 continues to operate the air compressor 24 with the electric power supplied from FC stack 10A, and supplies the air to each of FC stack 10B, 10C except for FC stack 10A. Further, the control device 50 drives the hydrogen supply system 30 of each of FC stacks 10B, 10C to supply hydrogen gases to each of FC stacks 10B, 10C. As a result, FC stacks 10B, 10C are activated at the time t4, and power generation is started.

Then, at time t5, the output voltage of FC stack 10B, 10C is increased to the vicinity of the upper limit output voltage, and the activation of FC stack 10B, 10C is completed. This completes the activation of FC device 2. In this way, the FC system 2 is relatively quick to start up because the FC stacks 10B, 10C are started up at the same timing.

According to the above configuration, FC stack 10A is activated by the blower 28 being operated with electric power supplied from the low-voltage power sources other than 10C from the respective FC stacks 10A (S14 from S10 of FIG. 4). After FC stack 10A is activated, when the output voltage of FC stack 10A exceeds the threshold value (YES by S16), FC stacks 10B, 10C except for FC stack 10A are activated by operating the air compressor 24 with the electric power supplied from FC stack 10A. In this way, 10C can be activated from a plurality of FC stacks 10A. In particular, FC system 2 does not need to be equipped with a high-voltage power supply (other than FC stack 10) for driving the air compressor 24 in order to activate 10A of 10C from a plurality of FC stacks.

### Second Embodiment

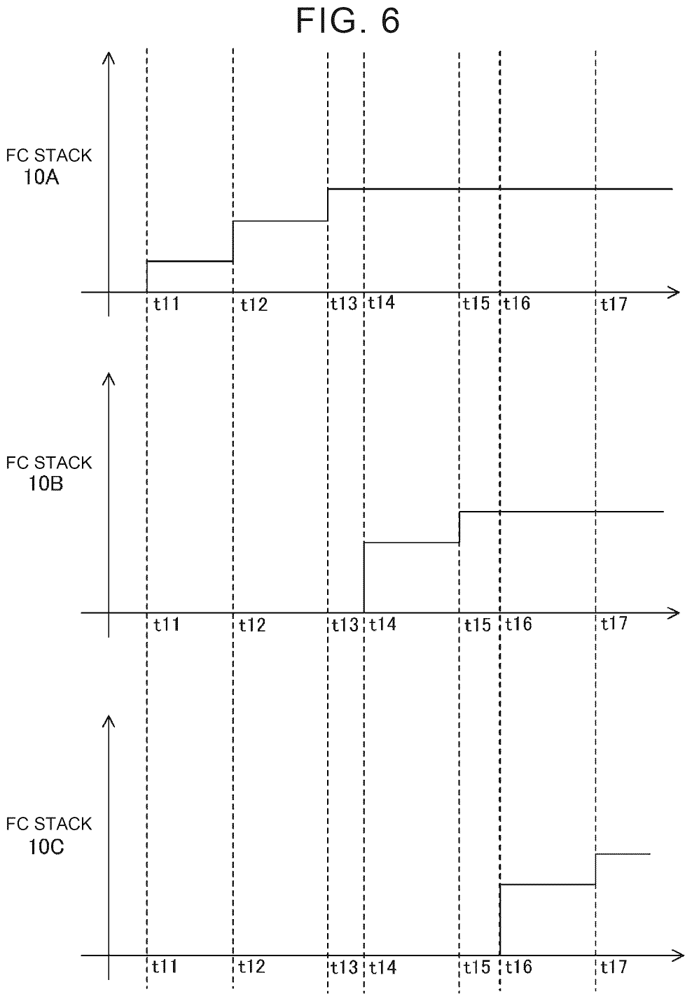

Next, a second embodiment will be described with reference to FIG. 6. The second embodiment differs from the first embodiment in the timing at which FC stacks 10B, 10C is activated. The configurations of FC device 2 are the same as those of the first embodiment. The process until the activation of FC stacking 10A is completed (that is, the process from the time t11 to t13 in FIG. 6) is the same as in the first embodiment.

In the time t14, the control device 50 continues to operate the air compressor 24 with electric power supplied from FC stack 10A and supplies air to FC stack 10B. In addition, the control device 50 drives the hydrogen supply system 30 in FC stack 10B to supply the hydrogen gas to FC stack 10B. As a result, FC stack 10B is activated at the time t14, and power generation is started. At t14 stage, FC stack 10C is not activated (i.e., does not generate electricity).

Then, at time t15, the output voltage of FC stack 10B is increased to the vicinity of the upper limit output voltage, and the activation of FC stack 10B is completed.

Thereafter, at time t16, the control device 50 continues to operate the air compressor 24 with the electric power supplied from FC stack 10A to supply air to FC stack 10C. In addition, the control device 50 drives the hydrogen supply system 30 in FC stack 10C to supply hydrogen to FC stack 10C. As a result, FC stack 10C is activated at the time t16, and power generation is started.

Then, at time t17, the output voltage of FC stack 10C is increased to the vicinity of the upper limit output voltage, and the activation of FC stack 10C is completed. This completes the activation of FC system 2.

In particular, in the second embodiment, the timing of activation of FC stack 10B differs from the timing of activation of FC stack 10C. With such a configuration, it is possible to suppress an event such as insufficient power for starting FC stacking 10B, 10C due to, for example, starting FC stacking 10B, 10C at the same timing.

Points to be noted with respect to the above embodiment. FC stack 10A corresponds to an exemplary “first fuel cell stack” of the present technique. The blower 28 and the air compressor 24 correspond to examples of the “first air supply device” and the “second air supply device” of the present technology, respectively. The processes from S10 to S14 in FIG. 4 correspond to an exemplary “first process” of the present technique. The processes of S18 and S20 in FIG. 4 correspond to an exemplary “second processing” of the present technique.

For example, a fan may be used instead of the blower 28. In the present modification, the fan is an example of the “first air supply device”.

Instead of the process of S16 in FIG. 4, it may be determined whether the activation of FC stacking 10A is completed. In this modification, the upper limit of FC stack 10A is an example of “predetermined threshold values”. In another variation, the air supply system 20A may not include the air compressor 24. That is, only the blower 28 may be used to activate FC stacking 10A.

While specific examples of the technology disclosed in the present specification have been described in detail above, these examples are merely illustrative and do not limit the scope of the claims. The technique described in the claims includes various modifications and variations of the specific examples exemplified above. The technical elements described in this specification or in the drawings may be used alone or in various combinations, and are not limited to the combinations described in the claims at the time of filing. In addition, the technique exemplified in the present specification or drawings can achieve a plurality of purposes at the same time, and achieving one of the purposes itself has technical usefulness.

What is claimed is:

1. A fuel cell system comprising:
a plurality of fuel cell stacks including a first fuel cell stack;
an air supply system configured to supply air to each of the fuel cell stacks;
a hydrogen supply system configured to supply hydrogen to each of the fuel cell stacks; and
a control device configured to control the air supply system and the hydrogen supply system to perform a start-up process for starting the fuel cell stacks, wherein the start-up process includes:
a first process for starting the first fuel cell stack by operating the air supply system with electric power supplied from a source other than the fuel cell stacks; and
a second process for starting the fuel cell stacks except the first fuel cell stack by operating the air supply system with electric power supplied from the first fuel cell stack after the first fuel cell stack is started.

2. The fuel cell system according to claim 1, wherein:
the air supply system includes a first air supply device and a second air supply device having a higher driving voltage than the first air supply device;
in the first process, the first air supply device is operated; and
in the second process, the second air supply device is operated.

3. The fuel cell system according to claim 2, wherein:
the second process is started after output electric power of the first fuel cell stack exceeds a predetermined threshold value; and
after the second process is started, air is supplied from the second air supply device to the first fuel cell stack instead of the first air supply device.

4. The fuel cell system according to claim 1, wherein in the second process, the fuel cell stacks except the first fuel cell stack are started at the same timing.

5. The fuel cell system according to claim 1, wherein in the second process, at least some of the fuel cell stacks except the first fuel cell stack are started at different timings.
